(19) United States
(12) Patent Application Publication
(10) Pub. No.: US 2026/0365348 A1
(43) Pub. Date: Nov. 19, 2026

(54) Tethered Communication and Selective Disconnection Architecture for a Multi-Drone Carrier UAV System

(71) Applicant: Ruslan Prysiazhnyi, Orlando, FL (US)

(72) Inventor: Ruslan Prysiazhnyi, Orlando, FL (US)

(21) Appl. No.: 19/686,963

(22) Filed: May 25, 2026

Related U.S. Application Data
(63) Continuation of application No. 19/206,747, filed on May 13, 2025.

(51) Int. Cl. B64U 80/82; B64U 10/60; B64U 70/20; B64U 80/30; B64U 101/18

(52) U.S. Cl. CPC B64U 80/82; B64U 10/60; B64U 70/20; B64U 80/30; B64U 2101/18; B64U 2201/20

(57) ABSTRACT

A tethered communication architecture for a carrier unmanned aerial vehicle uses a plurality of optical fibers to maintain individualized control links between a carrier unmanned aerial vehicle and respective deployed aerial vehicles. A control system transmits operational commands through the optical fibers, receives feedback signals from the deployed aerial vehicles, and supports selective release during flight. A disconnection mechanism selectively severs a selected optical fiber upon completion of a mission parameter, allowing the carrier to continue operation with remaining deployed or retained aerial vehicles.

### CROSS-REFERENCE TO RELATED APPLICATIONS

This application is a continuation of U.S. application Ser. No. 19/206,747, filed May 13, 2025, which claims the benefit of U.S. Provisional Application No. 63/650,933, filed May 23, 2024. The entire disclosures of the foregoing applications are incorporated herein by reference in their entireties.

### FIELD OF THE INVENTION

The present invention relates to unmanned aerial vehicle (UAV) systems and, more particularly, to tethered communication architectures for carrier UAV systems configured to deploy and control multiple aerial vehicles in electronic warfare environments.

### BACKGROUND OF THE INVENTION

Electronic warfare environments create substantial challenges for wireless UAV control systems due to jamming, interception, and spoofing. Existing deployable drone systems relying on RF communication are vulnerable to signal disruption and loss of control.

Accordingly, there exists a need for a tethered communication architecture capable of maintaining secure and interference-resistant communication between a carrier UAV and deployable aerial vehicles.

### SUMMARY OF THE INVENTION

The invention provides a tethered communication architecture for a carrier unmanned aerial vehicle system utilizing optical fiber communication links between a carrier UAV and multiple deployable aerial vehicles.

The architecture supports individualized communication channels, selective disconnection, simultaneous control of multiple deployed aerial vehicles, feedback signal transmission, and interference-resistant operation in electronic warfare environments.

### BRIEF DESCRIPTION OF THE DRAWINGS

FIG. 1 ILLUSTRATES A CARRIER UAV CONFIGURED TO TRANSPORT AND DEPLOY MULTIPLE AERIAL vehicles.

FIG. 2 illustrates deployment and communication control between a carrier UAV and deployable aerial vehicles.

FIG. 3 illustrates selective disconnection of an optical tether during mission completion.

### DETAILED DESCRIPTION OF THE INVENTION

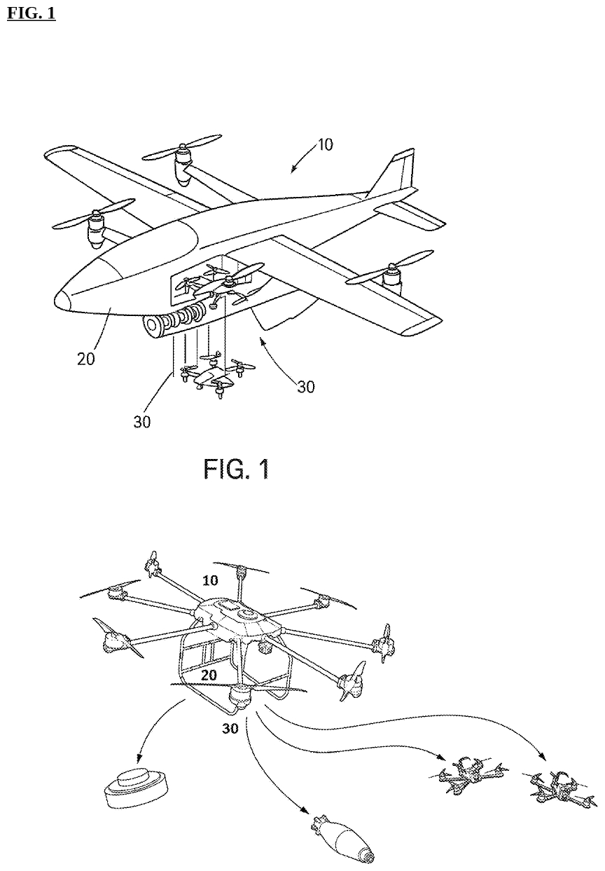

Referring to FIG. 1, a carrier unmanned aerial vehicle (UAV) 10 is configured to transport and deploy a plurality of deployable aerial vehicles. The carrier UAV 10 may comprise a carrier UAV or other aerial transport platform configured for autonomous or remotely controlled flight operations. A deployment compartment or payload section 20 is positioned within or beneath the carrier UAV 10 and is configured to store one or more deployable aerial vehicles prior to deployment.

A tether management system 30 is associated with the deployment compartment 20 and is configured to manage one or more optical fiber communication lines connected to respective deployable aerial vehicles. The tether management system 30 may comprise spool mechanisms, optical transmission interfaces, tension control mechanisms, deployment guides, and selective disconnection components.

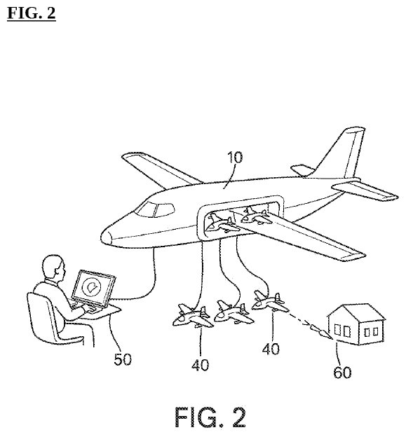

Referring to FIG. 2, the carrier UAV 10 may deploy multiple deployable aerial vehicles 40 during a mission while maintaining communication with an operator station 50. The deployable aerial vehicles 40 may include reconnaissance drones, surveillance drones, or attack drones configured to engage or monitor a target area 60.

Communication between the carrier UAV 10 and the deployable aerial vehicles 40 may be maintained through individual optical fiber links associated with each deployable aerial vehicle. The optical fiber links may transmit operational commands, navigation instructions, telemetry data, sensor information, video signals, and feedback signals between the carrier UAV 10 and the respective deployable aerial vehicles.

The optical fiber communication architecture may provide resistance to radio-frequency interference, electronic warfare jamming, signal interception, spoofing, and electromagnetic disruption. In some embodiments, the carrier UAV 10 may communicate with a remote operator through independent radio-frequency communication while maintaining optical-fiber communication with the deployable aerial vehicles.

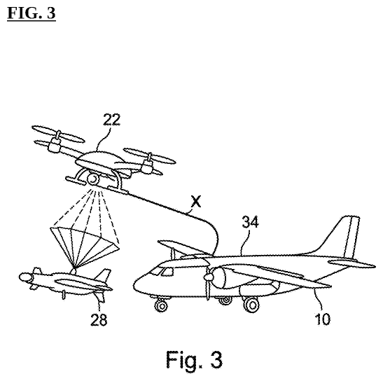

Referring to FIG. 3, a deployable aerial vehicle 22 may remain physically connected to the carrier UAV 10 through an optical fiber tether 34 during navigation toward a target or mission area. The deployable aerial vehicle 22 may carry a payload or munition 28 configured for surveillance, electronic warfare, or kinetic engagement operations.

A selective disconnection mechanism may sever a selected optical fiber tether 34 at a predetermined mission stage, operational condition, or engagement parameter. The severed section is schematically illustrated at X in FIG. 3. The selective disconnection mechanism may comprise a cutting element, thermal severing device, controlled severing device, electromechanical cutter, or other controlled disconnection mechanism. The symbol “X” in FIG. 3 schematically indicates a severed or disconnected section of the optical fiber tether.

In some embodiments, the carrier UAV 10 may simultaneously manage multiple deployed aerial vehicles through separate optical fiber communication channels. A communication management subsystem may include multiplexers, optical transceivers, signal processing units, routing modules, and feedback interfaces configured to support simultaneous control of multiple deployed aerial vehicles.

The disclosed architecture may be utilized in electronic warfare environments, reconnaissance missions, precision engagement operations, contested communication environments, and military or security operations requiring interference-resistant communication between a carrier UAV and deployed aerial vehicles.

The foregoing description is illustrative and not limiting. Various modifications and alternative configurations may be implemented without departing from the scope of the invention as defined by the appended claims.

As used herein, the term “deployable aerial vehicle” includes reconnaissance drones, surveillance drones, and attack drones.

1. A carrier unmanned aerial vehicle communication system, comprising: a carrier unmanned aerial vehicle configured to transport a plurality of deployable aerial vehicles; a fiber-optic tether system connected to the carrier unmanned aerial vehicle and comprising a plurality of optical fibers, each optical fiber being connectable to a respective one of the plurality of deployable aerial vehicles; a control system in communication with the fiber-optic tether system and configured to transmit control signals through the plurality of optical fibers to respective deployed aerial vehicles; and a disconnection mechanism configured to selectively sever a selected optical fiber upon completion of a predetermined mission parameter associated with the respective deployed aerial vehicle.

2. The system of claim 1, wherein the fiber-optic tether system comprises a spool mechanism for each optical fiber, each spool mechanism being configured to extend and retract the respective optical fiber during operation of the deployable aerial vehicles.

3. The system of claim 1, wherein the control system comprises a signal processing unit configured to convert operational commands into optical signals.

4. The system of claim 3, wherein the control system comprises a multiplexer configured to transmit the optical signals through multiple optical fibers simultaneously.

5. The system of claim 3, wherein the control system comprises a receiver configured to receive feedback signals from the plurality of deployable aerial vehicles through the fiber-optic tether system.

6. The system of claim 1, wherein each deployable aerial vehicle comprises an optical interface configured to receive the control signals through the fiber-optic tether system.

7. The system of claim 1, wherein the control system is configured to support real-time video feed, target tracking, and precision control through the fiber-optic tether system.

8. The system of claim 1, wherein the disconnection mechanism comprises a cutting element configured to physically sever the selected optical fiber.

9. The system of claim 1, wherein the respective deployable aerial vehicle remains physically tethered to the carrier unmanned aerial vehicle through the selected optical fiber during navigation toward a target.

10. A communication management subsystem for a carrier unmanned aerial vehicle configured to transport a plurality of deployable aerial vehicles, the communication management subsystem comprising: a plurality of link modules mounted on the carrier unmanned aerial vehicle, each link module being configured to manage a respective optical fiber coupled to a respective deployable aerial vehicle; a signal processing unit configured to generate optical control signals; a multiplexing unit configured to route the optical control signals through the plurality of optical fibers; and a feedback interface configured to receive signals from the deployable aerial vehicles through the plurality of optical fibers.

11. The communication management subsystem of claim 10, wherein each link module comprises a spool mechanism configured to pay out and take up the respective optical fiber.

12. The communication management subsystem of claim 10, wherein the multiplexing unit is configured to support simultaneous control of more than one deployed aerial vehicle during a mission.

13. The communication management subsystem of claim 10, further comprising a selective severing controller configured to command disconnection of one optical fiber while maintaining remaining optical fibers connected.

14. The communication management subsystem of claim 10, wherein the carrier unmanned aerial vehicle communicates with an operator through radio communication or fiber-optic communication independently of the plurality of optical fibers connected to the deployable aerial vehicles.

15. The communication management subsystem of claim 10, wherein the plurality of optical fibers provide interference-resistant communication in an electronic warfare environment.

16. A method of controlling a plurality of deployable aerial vehicles from a carrier unmanned aerial vehicle, comprising: coupling each of a plurality of deployable aerial vehicles to the carrier unmanned aerial vehicle with a respective optical fiber; releasing one or more of the deployable aerial vehicles from the carrier unmanned aerial vehicle while maintaining the respective optical fiber connection; transmitting operational commands from the carrier unmanned aerial vehicle through the respective optical fiber to the released deployable aerial vehicle; receiving feedback signals from the released deployable aerial vehicle through the respective optical fiber; and selectively severing the respective optical fiber after completion of a predetermined mission parameter.

17. The method of claim 16, further comprising simultaneously controlling multiple released deployable aerial vehicles through different optical fibers.

18. The method of claim 16, further comprising, after a first engagement attempt is unsuccessful, releasing another deployable aerial vehicle while maintaining control through another optical fiber.

19. The method of claim 16, further comprising returning the carrier unmanned aerial vehicle with at least one remaining connected deployable aerial vehicle after severing the respective optical fiber of the released deployable aerial vehicle.
